(19) United States
(12) Patent Application Publication
(10) Pub. No.: US 2009/0011673 A1
(43) Pub. Date: Jan. 8, 2009

(54) Porous carbonized fabric with high efficiency and its preparation method and uses

(75) Inventors: Tse-Hao Ko, Taichung (TW); Ching-Han Liu, Taichung (TW); Jian-Jun Huang, Taichung (TW); Yuankai Liao, Taichung (TW); Jui-Hsiang Lin, Taichung (TW); Chih-Jung Hung, Taichung (TW)

Correspondence Address: VENABLE LLP, P.O. BOX 34385, WASHINGTON, DC, 20043-9998, US

(73) Assignee: Feng Chia University, Taichung (TW)

(21) Appl. No.: 11/987,488

(22) Filed: Nov. 30, 2007

(30) Foreign Application Priority Data
Jul. 3, 2007 (TW) 096124119

(51) Int. Cl. H01M 4/96

(52) U.S. Cl. 442/189; 264/29.6; 429/44

(57) ABSTRACT

A porous carbonized fabric with high efficiency and its preparation method and uses are provided. The carbonized fabric is prepared from a mixed spun fabric containing an oxidized fiber and a polyamide fiber. The carbonized fabric has excellent gas permeability, high porosity, and good electric conductivity. The carbonized fabric can be used as the gas diffusion layer (electrode) material in a fuel cell. The fuel cell can provide a relatively high power density. Moreover, the carbonized fabric is useful as an anti-electromagnetic material and a reinforced composite material.

This application claims priority to Taiwan Patent Application No. 096124119 filed on Jul. 3, 2007.

### CROSS-REFERENCES TO RELATED APPLICATIONS

Not applicable.

### BACKGROUND OF THE INVENTION

1. Field of the Invention

The subject invention relates to a porous carbonized fabric with high efficiency and its preparation method and uses. In particular, the subject invention relates to a method for preparing a carbonized fabric useful in the gas diffusion layer of a fuel cell and to a carbonized fabric provided thereby.

2. Descriptions of the Related Art

Recently, as a result of the shortage of energy resources and greenhouse effect on Earth, the development of the hydrogen fuel cell has caught people's attention. Unlike a non-rechargeable battery, which is disposable and leads to environmental problems, the fuel cell does not need a time-consuming charging process. Also, the emissions of the fuel cell (such as water) are harmless to the environment.

Among all kinds of fuel cells, proton exchange membrane fuel cells (PEMFCs) and direct methanol fuel cells (DMFCs) can be operated under low temperature and generate high current density. Therefore, they are generally applied in power supply apparatuses of vehicles, united power systems, and 3C products (such as notebooks and mobile phones).

For PEMFCs, each singular cell comprises a membrane-electrode assembly (MEA) and bipolar plates with gas channels as the main components. In general, the MEA is composed of a proton exchange membrane (typically a polymer membrane which is used as an electrolyte), two catalyst layers placed at the two opposite sides of the proton exchange membrane, and two gas diffusion layers (also called “gas diffusion electrodes”) separately dis posed on the outside of the two catalyst layers. The catalyst can be directly coated onto the two sides of the proton exchange membrane to form a catalyst-coated proton exchange membrane and the gas diffusion layers are then placed on its two sides. Alternatively, the catalyst can be coated on the two gas diffusion layers and a proton exchange membrane is then placed between the two catalyst-coated gas diffusion layers. The MEA is inserted between two bipolar plates (usually made of graphite materials), and then, a shell packaging process is performed to provide a PEMFC. The PEMFC mechanism requires the hydrogen gas to pass through the gas diffusion layer to enter into the anode catalyst to generate hydrogen ions and electrons by catalysis. The electrons pass through the anode and move into the external circuit to form an electric current and the hydrogen ions pass through the proton exchange membrane to reach the cathode catalyst. Oxygen (or air) is introduced through the other gas diffusion layer into the cell to react with the hydrogen ions and the electrons from the external circuit to form water. The formed water can be directly drained out.

From the above, the gas diffusion layers have two major functions. First, the reaction gases can successfully diffuse into the catalyst layer and uniformly spread thereon due to the porous structure of the gas diffusion layers. Hence, a maximum electrochemical reaction area is provided. Second, the electrons produced from the anode catalysis are drained away from the anode to enter into the external circuit. Meanwhile, the electrons from the external circuit are introduced into the cathode catalyst layers. Accordingly, the gas diffusion layer should be a porous material and a good electric conductor. Furthermore, to prevent liquid water molecules from filling the pores of the gas diffusion layers and thus, impede the delivery of the reaction gas, the gas diffusion layers are usually subjected into a hydrophobic treatment in advance such that the reaction gases and the necessary water vapor can be successfully delivered to the catalyst layer.

Two kinds of gas diffusion layers are currently used, one of which is a carbon cloth and the other is a carbon paper. Usually, the cloth or paper has a thickness of less than 1 mm. In this aspect, U.S. Pat. No. 4,237,108 has disclosed a method for producing a carbon fabric, which comprises weaving acrylonitrile polymer fibers after a thermal setting treatment to provide a cloth; and then conducing an oxidation treatment (i.e., a thermal stabilization treatment) followed by a carbonization treatment to obtain a carbon fiber fabric. US 2004241078 A1 discloses the use of oxidized acrylic fibers as raw materials to conduct a spinning process and a weaving process to obtain an oxidized fiber cloth. Next, the oxidized fiber cloth is subjected to a carbonization process to provide a carbon fiber cloth.

Given the above, the objective of the subject invention is to provide a method for preparing a porous carbonized fabric with high efficiency. Here, the inventors of the subject application have found that the addition of the polyamide to the oxidized fibers can unpredictably improve the electric properties of the fiber fabric. In particular, when the obtained fabrics are used as the gas diffusion layers of fuel cells, the fuel cells exhibit outstanding power densities.

### SUMMARY OF THE INVENTION

One objective of the subject invention is to provide a method for preparing a porous carbonized fabric with high efficiency, comprising the following steps: providing a mixed spun fabric containing oxidized fibers and polyamide fibers, wherein the amount of the polyamide fibers ranges from about 1 wt % to about 90 wt %, based on the total weight of fibers; and thermally treating the fabric under the protection of an inert gas at a temperature ranging from about 700° C. to about 2500° C. for about 5 minutes to about 120 hours.

Another objective of the subject invention is to provide a porous carbonized fabric with a high efficiency, which is prepared by the above-mentioned method.

Yet another objective of the subject invention is to provide a fuel cell comprising an anode and a cathode, wherein at least one of the anode and cathode comprises the porous carbonized fabric with a high efficiency.

### BRIEF DESCRIPTION OF THE DRAWINGS

FIG. 1 is a flow chart showing an embodiment of the method for preparing the carbonized fabric according to the subject invention.

FIG. 2 shows a performance comparison (in voltage) between the fuel cells comprising the carbonized fabrics of the subject invention and the fuel cells of the prior art.

FIG. 3 shows a performance comparison (in power density) between the fuel cells comprising the carbonized fabrics of the subject invention and the fuel cells of the prior art.

### DESCRIPTION OF THE PREFERRED EMBODIMENT

The method for preparing the porous carbonized fabric with high efficiency according to the subject invention comprises the following steps:

(a) providing a mixed spun fabric containing oxidized fibers and polyamide fibers; and

(b) thermally treating the fabric under the protection of an inert gas at a temperature ranging from about 700° C. to about 2500° C. for about 5 minutes to about 120 hours.

In the method of the subject invention, the thermal treatment should be conducted with the protection of an inert gas to avoid the fiber ashing phenomenon during the thermal treatment. For example, the carbonization treatment can be carried out under an inner gas selected from a group consisting of nitrogen, helium, argon, and combinations thereof. According to the method of the subject invention, the shrinkage or elongation of the mixed spun fabric can be controlled during the thermal treatment. The shrinkage and elongation control can be achieved by adjusting the rate of supplying the mixed spun fabric to the furnace for the thermal treatment and the rate of providing the treated fabric from the furnace. In particular, if the providing rate is slower than the supplying rate, the mixed spun fabric is shrunk to avoid an excessively high permeability in the carbonized fabric. On the contrary, the mixed spun fabric can be stretched to provide a carbonized fabric with an improved strength, which is useful as a reinforcement material. In general, the shrinkage is controlled of no more than 40%, preferably no more than 25%, and the elongation is controlled of no more than 25%.

The thermal treatment of the method according to the subject invention can be performed in two stages, i.e., a two-stage thermal treatment comprising a first thermal treatment stage and a second thermal treatment stage. The first thermal treatment stage is performed at a temperature ranging from about 700° C. to about 1000° C. for about 5 minutes to about 120 hours, and the second thermal treatment stage is performed at a temperature ranging from about 1000° C. to about 2500° C. for about 5 minutes to about 120 hours. Thus, in the case of the two-stage thermal treatment, the shrinkage or elongation of the mixed spun fabric is usually controlled during the first thermal treatment stage.

The mixed spun fabric used in the method of the subject invention contains the oxidized fibers and polyamide fibers. Based on the total weight of fibers, the amount of the polyamide fibers ranges from about 1 wt % to about 90 wt %, preferably from about 5 wt % to about 50 wt %, and more preferably from about 10 wt % to about 40 wt %. It has been found that the addition of the polyamide fibers can improve the electric conductivity of the carbonized fabric obtained, which is useful as the material for a gas diffusion layer. In particular, the carbon fiber fabric provided from the raw materials of the oxidized fibers and the polyamide fibers can provide an unpredictably outstanding performance combination as it is applied in a fuel cell. Preferably, the fuel cell can provide an outstanding combination of maximum power, maximum power density, and load current density.

Any suitable polyamide fiber can be used in the method of the subject invention. For example, the polyamide fiber can be an aromatic polyamide fiber, the specific embodiments of which are such as Normex or Keviar produced by DuPont Co., Technora produced by Teijin Co., and Twaron produced by Teijin Twaron Co.

Any suitable oxidized fiber can be used in the method of the subject invention. In general, the oxidized fiber can be provided by thermally treating a fiber, selected from a group consisting of polyacrylonitrile (PAN) fibers, asphalt fibers, phenolic fibers, cellulose fibers, and combinations thereof. For example, an oxidized fiber can be provided by thermally treating a PAN fiber at a temperature ranging from about 200° C. to about 300° C. Moreover, commercially available fireproof fibers can be directly used as the oxidized fiber of the method of the subject invention, such as Panox produced by SGL Carbon Group Co., Pyromex produced by Toho Teanx Co., Pyron produced by Zoltek Co. and Lastan produced by Asahi Kasei Co. Such fireproof fibers have a diameter of above about 13 μm, a density of above about 1.35 g/cm³, and a limiting oxygen index (LOI) of above about 40%.

According to the method of the subject invention, the mixed spun fabric can be provided with the following steps:

(i) mixing the oxidized fibers and the polyamide fibers to provide a fiber mixture;

(ii) spinning the fiber mixture to provide a mixed spun yarn; and

(iii) weaving the mixed spun yarn to provide the mixed spun fabric.

For example, in the mixing step, the oxidized fibers and the polyamide fibers (both with a length ranging from about 5 mm to about 200 mm, and preferably from about 10 mm to 120 about mm) are placed into a spun machine for uniform dispersion to obtain a uniformly mixed tow. The amounts and species of the oxidized fibers and the polyamide fibers are as those mentioned above and are not further described herein.

Afterwards, the obtained fiber mixture is spun. The spinning process can be carried out in one step, or using a roving spinning step followed by a fine spinning step. In the latter, the fiber mixture is drafted 3 to 10 times to prepare a roving yarn, and then, the roving yarn is drafted 10 to 15 times to prepare a spun yarn, thereby, providing the desired mixed spun yarn. Thereafter, the spun yarns are optionally processed for doubling two strands of the spun yarns to provide double-strand mixed spun yarns.

Next, a weaving process can be performed using any suitable weaving technique, such as tatting, knitting or a combination thereof, to provide a mixed yarn fabric. The tatting manner can provide a mixed yarn fabric with a plain weave or a twill weave. The knitting manner can provide a mixed yarn fabric with a knitted structure. In the case of using the carbonized fabric of the subject invention as the gas diffusion layer material, the mixed yarn fabric should be prepared by tatting. Tatting is used because the gas diffusion layer should be able to allow the fuel gas to uniformly diffuse and a more smooth contact surface with the catalyst layer is usually desirable.

The mixed spun fabric used in the subject invention generally has the following physical properties: a thickness ranging from about 0.05 mm to about 1 mm, preferably from about 0.08 mm to about 0.8 mm; a yarn count ranging from about 5 s′ to about 100 s′, preferably from about 10 s′ to about 50 s′; and a yarn density ranging from about 5 yarns/in. to about 100 yarns/in., preferably from about 10 yarns/in. to about 80 yarns/in.

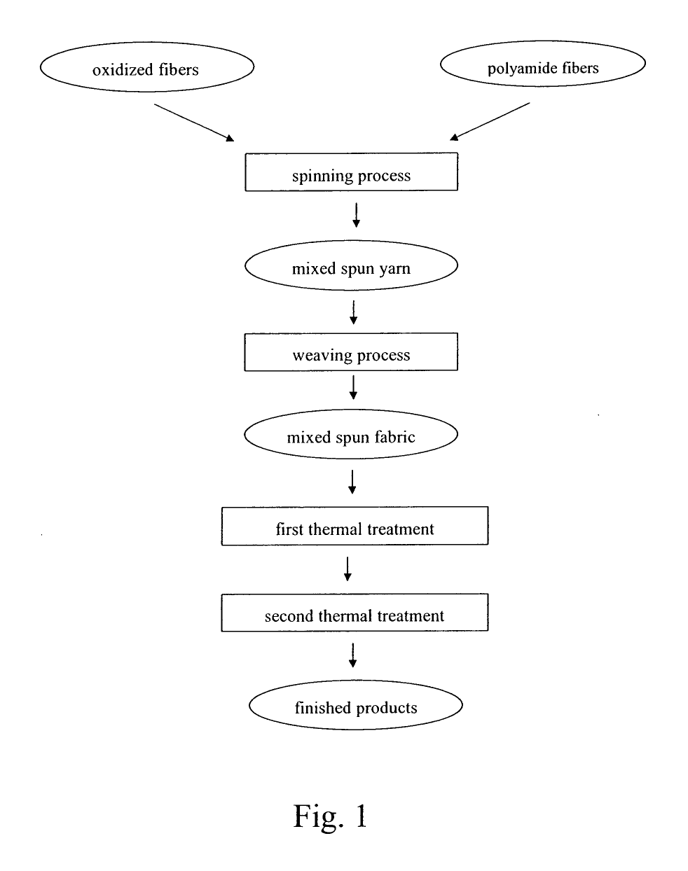

FIG. 1 shows an embodiment of the method for preparing the carbonized fabric according to the subject invention. Oxidized fibers and polyamide fibers are mixed uniformly and then subjected to a spinning process to provide a mixed spun yarn. The mixed spun yarn is subjected into a weaving process to provide a mixed spun fabric. Then, the fabric is thermally treated to obtain a final carbonized fabric (comprising the first thermal treatment stage and the second thermal treatment stage).

A porous carbonized fabric with high efficiency can be prepared using the above method. The fabric has properties of common carbonized fabrics and can also be used as a gas diffusion layer in the electrode of a fuel cell to provide a fuel cell with high power density.

Therefore, the subject invention further relates to a porous carbonized fabric with high efficiency, which is prepared using the above method. The carbonized fabric of the subject invention can be applied in a fuel cell and also is useful as an anti-electromagnetic material or a reinforcement composite material as common carbon fiber fabric.

The carbonized fabric of the subject invention usually has a true density ranging from about 1.2 g/cm³ to about 2.0 g/cm³, a thickness ranging from about 0.08 mm to about 0.8 mm, and a surface resistance of not higher than about 1.0 Ω/sq., and preferably, not higher than about 0.8 Ω/sq. As shown in the examples provided below, the carbonized fabric of the subject invention has a relatively low density as compared with the prior art, and thus, the weight of the applied article (such as fuel cell and anti-electromagnetic device) is reduced. Furthermore, the carbonized fabric of the subject invention has a good porosity and a good conductivity (i.e., low surface resistance). The carbonized fabrics can be directly applied in fuel cells (especially PEMFCs and DMFCs) as gas diffusion layer materials without being subjected to a hydrophobic treatment in advance. The fuel cells can still provide desired performances, such as high power densities.

The subject invention also relates to a fuel cell comprising an anode and a cathode, wherein at least one of the anode and cathode comprises the porous carbonized fabric with high efficiency according to the subject invention. Preferably, the anode and the cathode both are composed of a porous carbonized fabric with high efficiency. Here, the anode and cathode of the fuel cell are the so-called gas diffusion layers.

The fuel cell of the subject invention mainly comprises: an anode, a cathode and an electrolyte located between the anode and the cathode. The fuel cell further comprises an anode catalyst located between the anode and the electrolyte and a cathode catalyst located between the cathode and the electrolyte for conducting a catalytic reaction to provide electric energy. As described in the background, the materials and the structures of the components in fuel cells are well known by people having ordinary skill in this field. For example, Taiwan Patent Publication No. 1272739 and US 2007/0117005 A1 provide relevant descriptions and all of their disclosures are incorporated hereinto for reference.

The embodiments of the fuel cells of the subject invention include PEMFCs and DMFCs. For example, the PEMFC generally comprises an anode and/or a cathode (gas diffusion layers) composed of the carbonized fabric of the subject invention, a polymer proton exchange membrane (such as the Nafion serial products of DuPont Co.) as the electrolyte, and noble metal catalyst layers (such as palladium or platinum catalysts). A catalyst-coated proton exchange membrane (such as the product of Gore Co. of U.S.A., No. 5621 MESGA) can also be used in combination with the carbonized fabric of the subject invention to provide a PEMFC.

As shown in the testing results of the cell performance provided below, the power efficiency of the fuel cell with the carbonized fabric of the subject invention is significantly enhanced by adding the polyamide fibers to the raw material. The more the polyamide fibers are used, the better the power efficiency is attained. However, since the polyamide fibers are relatively expensive, in view of the cost, the amount of the polyamide fibers usually ranges from about 1 wt % to about 90 wt %, preferably from about 5 wt % to about 50 wt %, and more preferably from about 10 wt % to about 40 wt %. Under the testing conditions performed in the examples, the fuel cells comprising the carbonized fabric of the subject invention as the anode and the cathode have a maximum density of not less than about 600 mW/cm², preferably not less than about 700 mW/cm², and more preferably not less than about 750 mW/cm². Furthermore, the maximum power of the cells is not less than about 16 W, preferably not less than about 18 W, and more preferably not less than about 19 W.

The subject invention is further described in detail by referring to the examples provided below. The testing methods and equipments are illustrated as follows:

### (A) Density Measurement:

A sample was placed in an oven at 120° C. for 24 hours and then weighed using a 4-decimal number balance. Then, the sample was placed in the measuring place of the true density equipment (AccuPyc Co., No.: 1330). The true density equipment was filled up with helium gas and then purged, which was repeated ten times. Afterwards, the sample was measured 90 times. The mean value of the last ten times was adopted.

### (B) Permeability Measurement:

Permeability measuring equipment: Gurley Model 4320

Measuring norm: Model 4110

Capacity of the barrel for permeability: 300 cc

Weight of the barrel for permeability: 20 oz

Measuring area: 1 in.²

The barrel for the permeability measurement was checked to be put on the designed place prior to this experiment. A sample with an area of more than 1 in.² was placed on the holder of the permeability measuring equipment. The software was operated according to the Model 4110 standard measuring process provided by Gurley Co. and the barrel for permeability was put down slowly. After the barrel for permeability finished the whole procedure, a value (sec) was obtained. A lower value means a higher permeability of the sample, and vice versa.

### (C) Porosity Measurement:

Measuring norm: ASTM D-570 test method

A sample was placed in an oven of 120° C. for 24 hours and then taken out for weighing to obtain a value W₁. The dried sample was immersed in reverse osmosis water, taken out to wipe the water from its surface, and then weighed to obtain a value W₂. The porosity of the samples was calculated by the following formula:

[(W₂−W₁)/W₁]×100%=porosity(%)

### (D) Cell Performance Measurement:

Electron load model no.: Agilent 6060B

Temperature controller: Omega Co. (model no.: CN-76000)

Heater: Watlow Co.

Flow controller: Brooks Co.

Flow monitor: Protec Co. (model no.: PC-540)

The prepared sample was cut into a size of 5 cm×5 cm and then combined with a catalyst-coated proton membrane (produced by Gore Co. of U.S.A., model no.:5621 MESGA) to provide an MEA without subjected first to any hydrophobic treatment or leveling treatment. Graphite plates with serpentine-type trenches were used as the bipolar plates. Then, the stainless steel and the polytetrafluoroethylene packing were used to conduct the final packaging to form a fuel cell. The cell performance was tested with a gas (H₂) flow rate at the anode at 200 cc/min, the gas (O₂) flow rate at the cathode at 200 cc/min, the pressure at 1 kg/cm², and the temperature at 40° C.

### (E) Penetrating Resistance Measurement:

The real volume (Vᵣₑₐₗ) of a sample was obtained by a true density equipment. The real area (Aᵣₑₐₗ) of each 1 cm² under a pressure of 300 kPa was calculated by dividing the real volume with the thickness of the sample. The sample was clipped by two copper slices, the terminal loading was set at 300 kPa under a tester, and then the resistance under a pressure of 300 kPa was obtained by an ohmmeter. The resistance coefficient was calculated using the following formula:

resistance value (Ω)=resistance coefficient (ρ)×thickness/real area

### EXAMPLE 1

Pyromex produced by Toho Tenax Co. and Twaron produced by Teijin Twaron Co. were respectively used as the oxidized fibers and polyamide fibers, both of which were short fibers with a length of 50 mm.

After 70 wt % of the oxidized fibers and 30 wt % of the polyamide fibers were uniformly mixed, the mixture were drafted using a roving spinning machine to provide a roving yarn, and then again drafted using a fine spinning machine to obtain a spun yarn. Thereafter, the spun yarn was doubled to provide a double-strand yarn of 20/2′.

The double-strand yarns were used as warp yarns and filling yarns to perform a 2/2 twill-weaving with a warp density of 32 yarns/in. and a filling density of 26 yarns/in. A mixed spun fabric with a thickness of 0.57 mm and a weight of 250 g/m² was then obtained.

The obtained mixed spun fabric was subjected to a first thermal treatment with the protection of nitrogen gas at a temperature of 1000° C. for 5 minutes and its shrinkage was controlled at 20%. After that, the mixed spun fabric was subjected to a second thermal treatment under nitrogen gas at a temperature of 1400° C. for 5 minutes to obtain the final carbonized fabric. The carbonized fabric had a warp density of 40 yarns/in. and a filling density of 36 yarns/in. Other physical properties are shown in Table 1.

Next, the obtained carbonized fabric was subjected to a cell performance measurement, wherein the fabric was not subjected to any hydrophobic treatment or leveling treatment. The results are shown in Table 2.

### EXAMPLE 2

Pyromex produced by Toho Tenax Co. and Technora produced by Teijin Co. were respectively used as the oxidized fibers and polyamide fibers, both of which were short fibers with a length of 50 mm.

The mixing, spinning, and doubling processes of Example 1 were repeated to obtain a double-strand yarn of 20/2′, but the amounts of the oxidized fibers and the polyamide fibers were 86 wt % and 14 wt %, respectively.

The double-strand yarns were used as warp yarns and filling yarns in plain-weaving with a warp density of 27 yarns/in. and a filling density of 24 yarns/in. A mixed spun fabric with a thickness of 0.47 mm and a weight of 215 g/m² was then obtained.

The mixed spun fabric was thermally treated using the same conditions as those described in Example 1 to obtain a carbonized fabric. The carbonized fabric has a warp density of 32 yarns/in. and a filling density of 26 yarns/in. Other physical properties are shown in Table 1.

Next, the obtained carbonized fabric was subjected to the cell performance measurement, wherein the fabric was not subjected to any hydrophobic treatment or leveling treatment. The results are shown in Table 2.

### COMPARATIVE EXAMPLE 1

A carbon fiber fabric (manufactured by Challenge Carbon Technology Co. Ltd., No.: FCW 1005) produced from a cloth (woven from 100% oxidized fibers) under the protection of nitrogen gas at a temperature of 1000° C. was used. The fabric had a thickness of 0.53 mm and a weight of 233 g/m².

The above carbon fiber fabric was thermally treated under the protection of nitrogen gas at a temperature of 1400° C. for 5 minutes. The fabric obtained had a warp density of 21 yarns/in. and a filling density of 12 yarns/in. Other physical properties are shown in Table 1.

Next, the obtained carbonized fabric was subjected to a cell performance measurement, wherein the carbonized fabric was not first subjected into any hydrophobic treatment or leveling treatment. The results were shown in Table 2.

### COMPARATIVE EXAMPLE 2

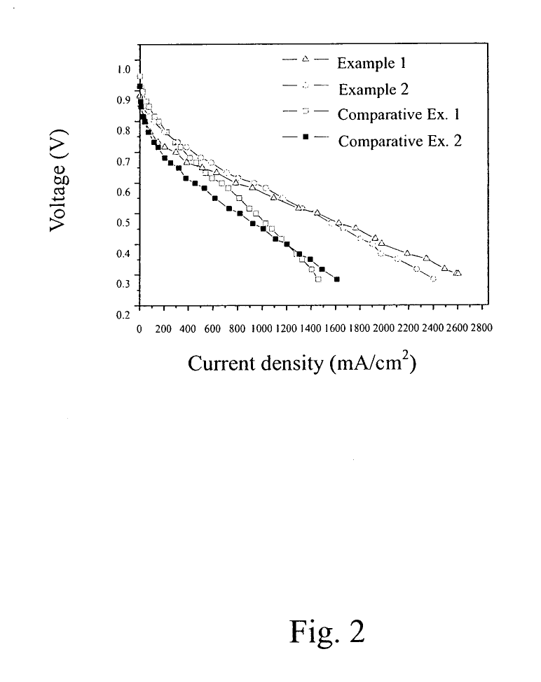

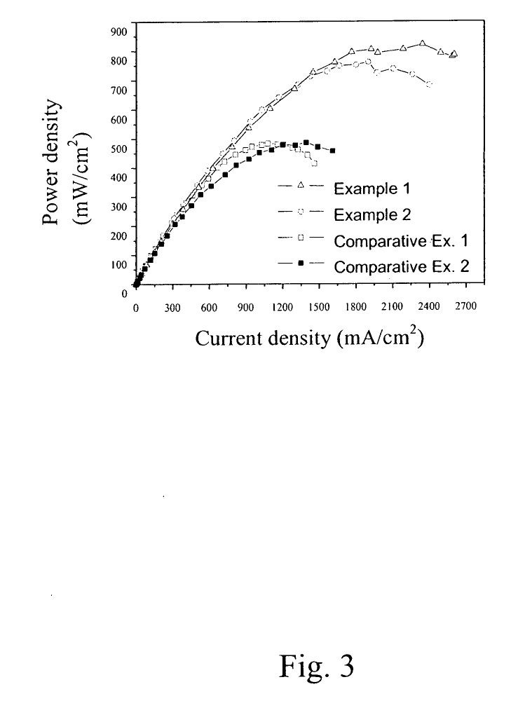

A carbon cloth (manufactured by ElectroChem Co., No.: EC-CC1-060) which was used in the gas diffusion layer of commercial fuel cells was used. The carbon cloth had a warp density of 20 yarns/in. and a filling density of 20 yarns/in. Other physical properties are shown in Table 1. The carbon cloth was further subjected to the cell performance measurement and the results are shown in Table 2, FIG. 2, and FIG. 3.

TABLE 1
The physical properties of the carbonized fabrics

| | | | | Resistance in | | | |
|---|---|---|---|---|---|---|---|
| | | | True | the direction | Surface | | |
| | Weight | Thickness | density | of thickness | resistance | Permeability | Porosity |
| | (g/m²) | (mm) | (g/cm³) | (Ωcm) | (Ω/sq.) | (cm³/cm²/s) | (%) |
| Example 1 | 152 | 0.56 | 1.607 | 2.36 | 0.626 | totally | 286 |
| | | | | | | permeated | |
| Example 2 | 128 | 0.47 | 1.663 | 2.78 | 0.646 | totally | 215 |
| | | | | | | permeated | |
| Comparative | 233 | 0.53 | 1.773 | 2.84 | 0.323 | 46.5 | 163 |
| Example 1 | | | | | | | |
| Comparative | 116 | 0.33 | 1.750 | 1.56 | 0.573 | 163 | 201 |
| Example 2 | | | | | | | |

TABLE 2
The testing results of the fuel cells

| | | Max. power | Current density |
|---|---|---|---|
| | Max. power | density | (0.5 V load) |
| | (W) | (mW/cm²) | (mA/cm²) |
| Example 1 | 21.8 | 871 | 1668 |
| Example 2 | 19.7 | 787 | 1518 |
| Comparative | 12.0 | 480 | 948 |
| Example 1 | | | |
| Comparative | 12.2 | 487 | 819 |
| Example 2 | | | |

It can be noted from Table 1 and Table 2 that the mixed fabrics of the subject invention (obtained in Examples 1 and 2) had better permeabilities, porosities, lower densities and better combinations of cell performance (as shown in FIG. 2 and FIG. 3), as compared with the carbonized fabric produced by only the oxidized fibers (Comparative Example 1) and the commercial carbon cloth (Comparative Example 2).

### EXAMPLE 3

The same manufacturing process and raw materials described in Example 1 were adopted, but the second thermal treatment was performed at a temperature of 1750° C. The carbonized fabric obtained had a warp density of 20 yarns/in. and a filling density of 16 yarns/in. Other physical properties are shown in Table 3.

### EXAMPLE 4

The same manufacturing process and raw materials described in Example 2 were adopted, but the second thermal treatment was performed at a temperature of 1750° C. The carbonized fabric obtained had a warp density of 32 yarns/in. and a filling density of 26 yarns/in. Other physical properties are shown in Table 3.

### COMPARATIVE EXAMPLE 3

The same manufacturing process and raw materials described in Comparative Example 1 were adopted, but the second thermal treatment was performed at a temperature of 1750° C. The carbonized fabric obtained had a warp density of 21 yarns/in. and a filling density of 12 yarns/in. Other physical properties are shown in Table 3.

TABLE 3
the physical property table of the carbonized fabrics

| | | | | Resistance in | |
|---|---|---|---|---|---|
| | | | True | the direction of | Surface |
| | Weight | Thickness | density | thickness | resistance |
| | (g/m²) | (mm) | (g/cm³) | (Ωcm) | (Ω/sq.) |
| Example 3 | 150 | 0.56 | 1.489 | 1.60 | 0.420 |
| Example 4 | 123 | 0.44 | 1.492 | 1.71 | 0.559 |
| Comparative | 224 | 0.52 | 1.501 | 1.80 | 0.268 |
| Example 3 | | | | | |

Table 1 and Table 3 show that the mixed spun fabrics of the subject invention had lower resistances and better electric conductivities as the temperature of the thermal treatment was raised.

The above examples are intended for illustrating the embodiments of the subject invention and the technical features thereof, but not for restricting the scope of protection of the subject invention. Any modification or equivalent arrangements which can be easily accomplished by people skilled in this field are within the scope of the subject invention. The scope of the subject invention is based on the claims as appended.

What is claimed is:

1. A method for preparing a porous carbonized fabric with high efficiency, comprising the following steps:
providing a mixed spun fabric containing oxidized fibers and polyamide fibers, wherein the amount of the polyamide fibers ranging from about 1 wt % to about 90 wt %, based on the total weight of fibers; and
thermally treating the fabric under the protection of an inert gas at a temperature ranging from about 700° C. to about 2500° C. for about 5 minutes to about 120 hours.

2. The method according to claim 1, wherein during the thermal treatment, the fabric is controlled under a fiber shrinkage of no more than about 40%.

3. The method according to claim 2, wherein during the thermal treatment, the fabric is controlled under a fiber shrinkage of no more than about 25%.

4. The method according to claim 1, wherein the inert gas is selected from a group consisting of nitrogen, helium, argon, and combinations thereof.

5. The method according to claim 1, wherein the thermal treatment comprises a first thermal treatment stage and a second thermal treatment stage, the first thermal treatment stage is performed at a temperature ranging from about 700° C. to about 1000° C. for about 5 minutes to about 120 hours, and the second thermal treatment step is performed at a temperature ranging from about 1000° C. to about 2500° C. for about 5 minutes to about 120 hours.

6. The method according to claim 5, wherein in the first thermal treatment stage, the fabric is controlled under a fiber shrinkage of no more than about 40%.

7. The method according to claim 6, wherein in the first thermal treatment stage, the fabric is controlled under a fiber shrinkage of no more than about 25%.

8. The method according to claim 1, wherein in the fabric, the amount of the polyamide fibers ranges from about 5 wt % to about 50 wt %, based on the total weight of fibers.

9. The method according to claim 8, wherein in the fabric, the amount of the polyamide fibers ranges from about 10 wt % to about 40 wt %, based on the total weight of fibers.

10. The method according to claim 1, wherein the polyamide fibers comprise cyclic polyamide fibers.

11. The method according to claim 1, wherein the oxidized fibers are prepared from thermally treating polyacrylonitrile fibers.

12. The method according to claim 1, wherein the fabric is prepared by the following steps:
mixing the oxidized fibers and the polyamide fibers to provide a fiber mixture;
spinning the fiber mixture to provide a mixed spun yarn; and
weaving the mixed spun yarn to provide the mixed spun fabric.

13. A porous carbonized fabric with high efficiency, which is prepared by the method according to claim 1.

14. The carbonized fabric according to claim 13, which is used as an anti-electromagnetic material or a reinforced composite material, or used in a gas diffusion layer material of a fuel cell.

15. The carbonized fabric according to claim 13, which has a true density ranging from about 1.2 g/cm³ to about 2.0 g/cm³.

16. The carbonized fabric according to claim 13, which has a surface resistance of not higher than about 1.0 Ω/sq.

17. A fuel cell comprising an anode and a cathode, wherein at least one of the anode and the cathode comprises the carbonized fabric according to claim 13.

18. The fuel cell according to claim 17, wherein both the anode and the cathode comprise the carbonized fabric according to claim 13.

19. The fuel cell according to claim 17, which is a proton exchange membrane fuel cell or a direct methanol fuel cell.
